(19) United States
(12) Patent Application Publication
(10) Pub. No.: US 2014/0222535 A1
(43) Pub. Date: Aug. 7, 2014

(54) METHOD AND SYSTEM FOR CARD MARKETING USING EXPENDITURE DETAILS OF AN INDIVIDUAL

(71) Applicant: Jeong-Yeop Kim, Seoul (KR)

(72) Inventor: Jeong-Yeop Kim, Seoul (KR)

(73) Assignee: KT CORPORATION, Seongnam-si (KR)

(21) Appl. No.: 14/343,563

(22) PCT Filed: Sep. 6, 2012
(86) PCT No.: PCT/KR2012/007142

§ 371 Date: Apr. 10, 2014

(30) Foreign Application Priority Data
Sep. 7, 2011 (KR) 10-2011-0090594

(51) Int. Cl. G06Q 30/02

(52) U.S. Cl. CPC G06Q 30/0269; G06Q 30/0222
USPC 705/14.23; 705/14.66

(57) ABSTRACT

The present invention relates to a method and a system for card marketing which collect benefit information about member stores of various financial cards, such as credit and debit cards, used for payment from all of the affiliated card companies and manage the collected benefit information, calculate the quantity of benefits for each card with respect to expenditure details of a financial card, cash, and banking of an individual in each member store without discriminating a company's own card from cards from other companies and recommend an optimum card having the largest benefits, and connect the card benefit information to an advertisement or induce the individual to be issued a new card, thereby effectively accomplishing card marketing.

### TECHNICAL FIELD

This application claims priority to and the benefit of Korean Patent Application No. 10-2011-0090594 filed in the Korean Intellectual Property Office on Sep. 7, 2011, the entire contents of which are incorporated herein by reference.

The present invention relates to a method and a system for card marketing, and particularly, to a method and a system for card marketing, which collect benefit information about member stores of various financial cards, such as credit and debit cards, used for payment from all of the card affiliated companies and manage the collected benefit information, calculate the quantity of benefits for each card with respect to expenditure details of a financial card, cash, and banking of an individual in each member store without discriminating a company's own card from cards from other companies and recommend an optimum card having the largest benefits, and connect the card benefit information to an advertisement or induce the individual to be issued a new card, thereby effectively accomplishing card marketing.

### BACKGROUND ART

Card companies issuing various financial cards, such as credit cards and debit cards, and providing services calculate sales on the basis of transaction fees, which the card companies receive from card member stores when customers use the card companies' own cards. Accordingly, the card companies take efforts to do market their cards in order to contribute to an increase in sales by promoting customers to frequently use their cards among various cards in customers' wallets by various methods.

Card companies provide a discount for affiliated member stores through affiliated marketing, and customers use a card of a corresponding company for receiving discount benefits. In general, an affiliated store and a card company bear expenses by 50% each according to affiliate discount. There are cherry picker-type customers, who receive only an affiliate discount, but are unhelpful to sales of a card company, but the cherry picker-type customers correspond to some customers.

However, the card companies publicizes discount for affiliated member stores through on-line/off-line advertisements, but there are many cases where it is difficult for customers possessing too many cards to recognize a card, which finally provides the large discount benefit to the customers when being used, among cards provided from the great number of card companies. For example, in a case where a customer using three cards uses the cards in several member stores, benefit of each card may be confirmed whenever the card is used, but in a case where the user does not use only the same card in all of the member stores, there is inconvenience that the user may recognize which card has large benefit only after checking the cards one by one and calculating the received benefits.

In addition, the card companies may suggest use of other cards of the card companies having more benefit through a self customer relationship management (CRM) simulation based on financial information about customers of the card companies, but the card companies cannot recognize which other card companies' cards the customers use, and thus it is impossible to do marketing using use details of other card companies' cards. It is realistically impossible for all of the card companies to share information about authentication details, and the like of a customer card, so that there is a limit in doing a marketing activity for possessors of other companies' cards.

### DETAILED DESCRIPTION OF THE INVENTION

### Technical Problem

Accordingly, an object of the present invention is to solve the aforementioned problem, and is to provide a method and a system for card marketing, which collect benefit information about member stores of various financial cards from all of the affiliated card companies and manage the collected benefit information, perform simulation when a customer inputs expenditure details of cash and banking, as well as the financial card, at each of the member stores by various methods, and thus recommend an optimum card having the large benefit by calculating the quantity of benefits for each card without discriminating a company's own card and cards of other companies, and connect the card benefit information to an advertisement or induce the customer to be issued a new card, thereby effectively accomplishing the card marketing.

### Technical Solution

First, to summarize the characteristic of the present invention, in accordance with an aspect of the present invention in order to achieve an object of the present invention, there is provided a method of card marketing for inducing and promoting use of an optimum card, including: (A) collecting benefit information (affiliated card information) about member stores of various financial cards and maintaining the collected benefit information (affiliated card information) in a database; (B) receiving information on actual expenditure details of a user at one or more member stores for a specific period; and (C) comparing the information about the expenditure details and the affiliated card information, and providing a card expected benefit result for a corresponding financial card when the user uses one or more financial cards in the affiliated card information at the one or more member stores.

Step (C) may include comparing information on a name and a position of a member store for each card included in the affiliated card information, and information on a name and a position of a member store for each expenditure amount of money included in the information about the expenditure details, and providing a card expected benefit result of a financial card to be used at the one or more member stores of which information on names and locations are matched with the information on the name and the position of the corresponding member store.

The information about the expenditure details may include information on a name and a position of a member store for each expenditure money paid by a financial card, cash, or banking.

Step (B) may include receiving information about expenditure details from a plurality of member stores, and step (C) may include providing a corresponding card expected benefit result when only a corresponding financial card is used at the plurality of member stores for each of all of the corresponding financial cards.

The card expected benefit result may include a benefit result when a corresponding expenditure financial card is used at the plurality of member stores according to expenditure details for use of the financial card in the information about the expenditure details.

The method may further include: separately displaying, on a display means, and providing a name of an optimum financial card having the highest discount amount of money and benefit information about the corresponding financial card included in the card expected benefit result in all of the corresponding financial cards as recommendation information.

The benefit information about the optimum financial card may include the discount amount of money or a discount rate at one or more member stores.

The method may further include transmitting the name of the optimum financial card and the benefit information about the corresponding financial card to a server on a network, which provides a promotion service, such as an SNS, and promoting the corresponding financial card.

The method may further include determining whether the optimum financial card is a currently possessed card of the user, and performing a procedure of inducing the user to apply new subscription of the optimum financial card when the user does not possess the optimum financial card.

Further, in accordance with another aspect of the present invention, there is provided a system for card marketing for inducing and promoting use of an optimum card, including: an affiliated card information management unit configured to collect benefit information (affiliated card information) about member stores of various financial cards and manage the collected benefit information (affiliated card information) in a database; an expenditure detail input unit configured to receive information about expenditure details at one or more member stores input by a user; an expenditure simulation unit configured to compare the information about the expenditure details and the affiliated card information, and provide a card expected benefit result for a corresponding financial card when the user uses one or more financial cards in the affiliated card information at the one or more member stores.

### Advantageous Effects

According to the method and the system for card marketing of the present invention, it is possible to collect benefit information about member stores of various financial cards from all of the affiliated card companies and manage the collected benefit information, and calculate the quantity of benefits for each card without discriminating a company's own card and cards of other companies, and recommend an optimum card having the better quantity of benefits according to a request of a simulation by inputting, by a customer, expenditure details of cash, banking, and the like, as well as a financial card at each of the member stores by various methods.

Further, card benefit information including an optimum card benefit may be connected with an advertisement through an SNS and the like or induce a customer to be issued a new card, thereby effectively accomplishing card marketing.

### BRIEF DESCRIPTION OF DRAWINGS

FIG. 1 is a diagram for describing a card marketing system according to an exemplary embodiment of the present invention.

FIG. 2 is a detailed block diagram illustrating a card marketing server according to the exemplary embodiment of the present invention.

FIG. 3 is a diagram for describing collection of affiliated card information according to the exemplary embodiment of the present invention.

FIG. 4 is a diagram for describing an input of expenditure detail information of an individual according to the exemplary embodiment of the present invention.

FIG. 5 is a flowchart for describing an operation of the card marketing system according to the exemplary embodiment of the present invention.

FIG. 6 is a flowchart for describing a process of searching for card benefit information according to the exemplary embodiment of the present invention.

### BEST MODE

Hereinafter, exemplary embodiments of the present invention will be described in detail with reference to the accompanying drawings, and contents described in the accompanying drawings, but the present invention is not restricted or limited by the exemplary embodiments of the present invention.

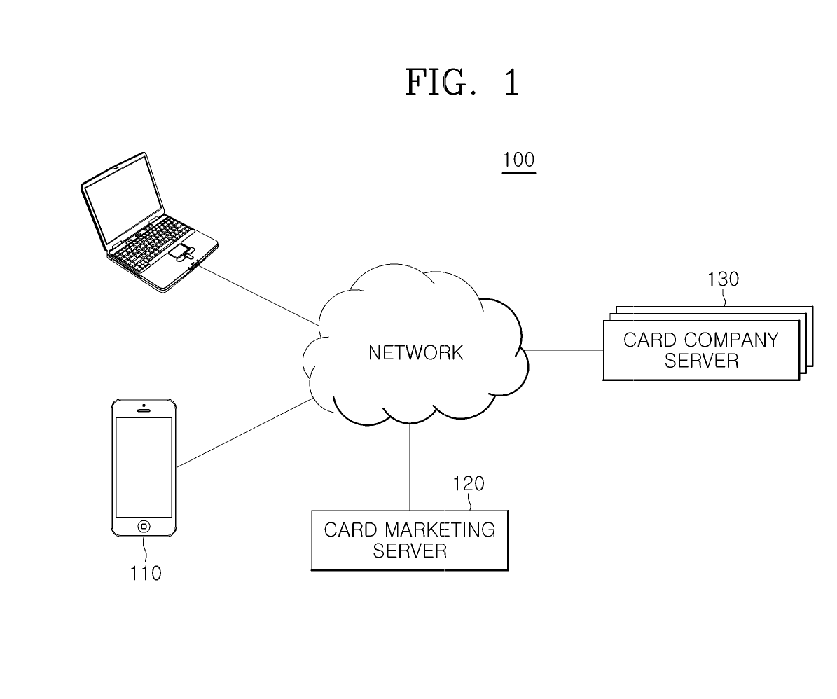

FIG. 1 is a diagram for describing a card marketing system 100 according to an exemplary embodiment of the present invention.

Referring to FIG. 1, the card marketing system 100 according to the exemplary embodiment of the present invention includes a user terminal 110, a card marketing server 120, and a card company (a company issuing a financial card, such as a credit card and a debit card) server 130, which are interlockable with each other through a network of a mobile communication network, such as the wired/wireless Internet, WCDMA, WiFi, and WiBro.

The user terminal 110 mentioned in the present invention may be a smart phone, but is not limited thereto, and may include a notebook personal computer (PC), a desktop PC, a palm PC, a cellular phone, and a personal communications services (PCS) phone which are capable of communicating through a network, synchronous/asynchronous international mobile telecommunication (IMT) 2000, a personal digital assistant (PDA), a wireless application protocol (WAP) phone, a mobile play-station, and other portable multimedia players (PMP), or portable or mobile terminals, which are capable of establishing wireless communication, and various electronic devices or apparatuses communicatable with other electronic devices general for home use or industrial society use.

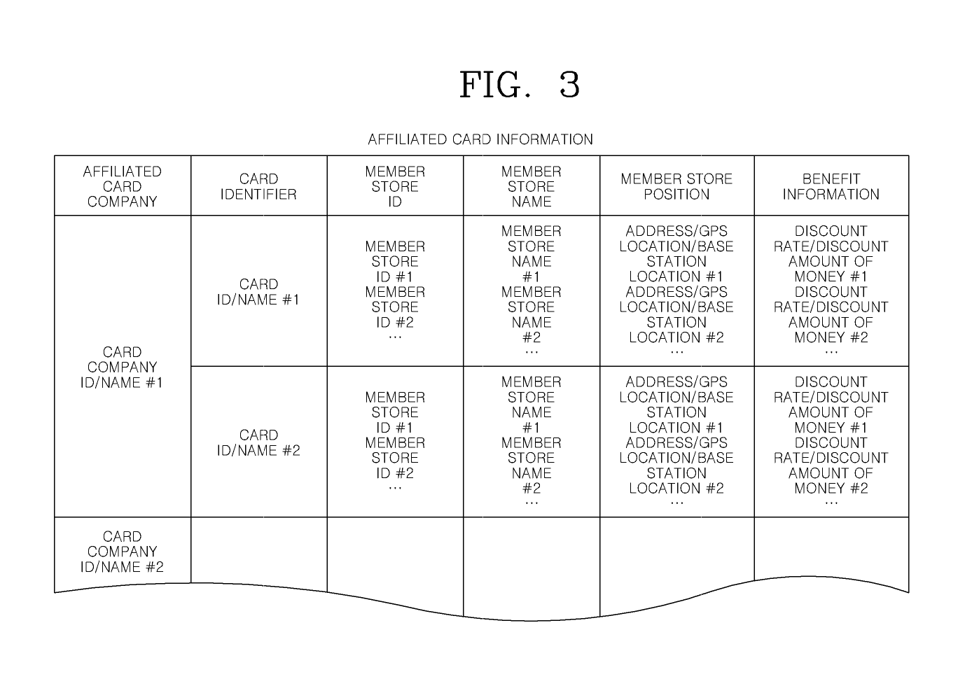

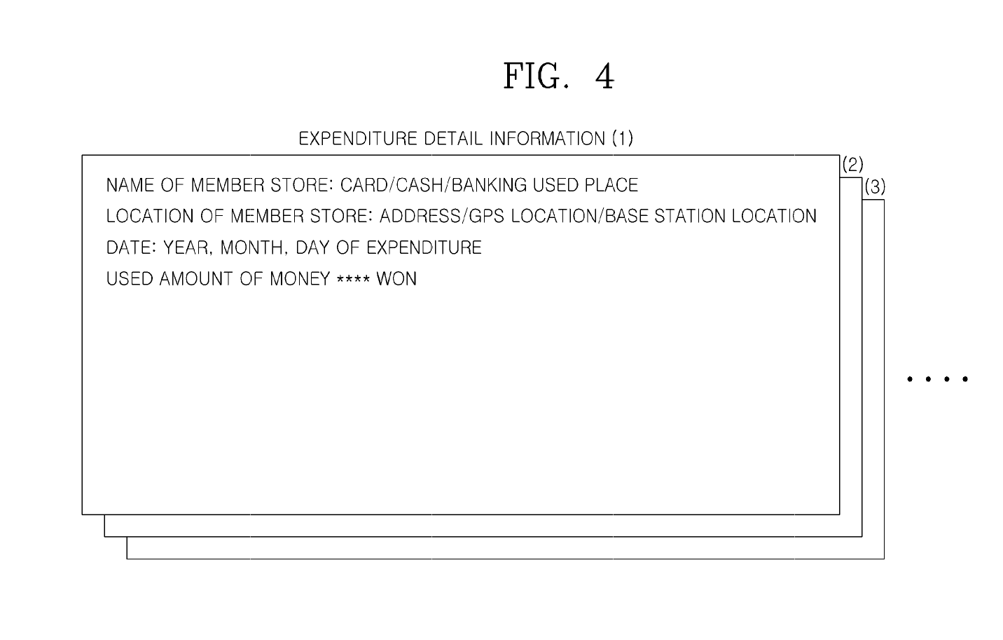

The card marketing system 100 for inducing and promoting use of an optimum card through the card marketing server 120 on the network according to the present invention may collect benefit information (affiliated card information) (see FIG. 3) for member stores of various financial cards from the card company servers 130 and the like, and maintain the collected benefit information in a database of the card marketing server 120, receive information (see FIG. 4) about actual expenditure details (financial card, cash, banking payment, or the like) at one or more member stores input through the user terminal 110 by a user, compare the information about the corresponding expenditure details and the affiliated card information of the database, and provide a card expected benefit result for a corresponding financial card when the user uses one or more financial cards in the affiliated card information at the one or more member stores, and in this case, the card marketing system 100 may recommend or advertise a name of an optimum financial card having the highest discount amount of money and benefit information (discount amount of money, a discount rate, or the like) of the corresponding financial card included in the card expected benefit result among all of the financial cards corresponding to the affiliated card information.

As described above, the present invention may collect benefit information about member stores of various financial cards from all of the affiliated card companies and manage the collected benefit information, and calculate the quantity of benefits for each card without discriminating a company's own card from cards of other companies and recommend an optimum card having a better quantity of benefits according to a request of a simulation from a customer by, the customer, inputting expenditure details of cash and banking, as well as a financial card, at the respective member stores by various methods, and connect the card benefit information (a name of the optimum financial card and benefit information about the corresponding financial card) including the optimum card benefit with an advertisement through a social network service (SNS) and the like, or induce a user, who does not currently possess the corresponding card, to be issued a new card, thereby effectively accomplishing card marketing.

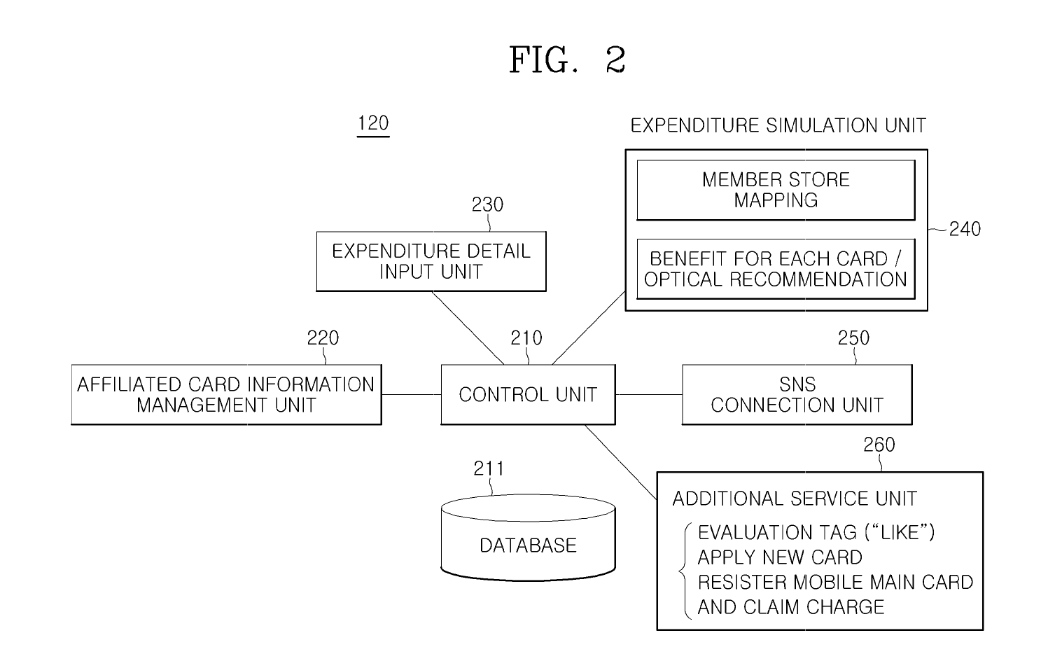

The aforementioned card marketing system 100 according to the exemplary embodiment of the present invention will be described in detail with reference to FIGS. 2 to 6 below.

FIG. 2 is a detailed block diagram illustrating the card marketing server 120 according to the exemplary embodiment of the present invention.

FIG. 2 is a block diagram of the card marketing server 120. Referring to FIG. 2, the card marketing server 120 includes a control unit 210, a database 211, an affiliated card information management unit 220, an expenditure detail input unit 230, an expenditure simulation unit 240, an SNS connection unit 250, and an additional service unit 260. The aforementioned constituent elements of the card marketing server 120 according to the exemplary embodiment of the present invention may be implemented by hardware, software, or a combination thereof.

First, an operation of each part of the card marketing server 120 will be described in detail below.

The control unit 210, which is a processor performing general control of the constituent elements of the card marketing server 120, may be implemented with some of the aforementioned constituent elements.

Benefit information (affiliated card information) about member stores of various financial cards illustrated in FIG. 3, which the affiliated card information management unit 220 collects and stores, is may be managed in the database 211, and information about actual expenditure details at one or more member stores illustrated in FIG. 4 of a user's input received by the expenditure detail input unit 230 may be managed in the database 211, and a result of a simulation performed by the expenditure simulation unit 240 may be stored and managed in the database 211. In addition, membership information, that is, an ID, a password, and a subscriber terminal identifier (terminal telephone number, universal subscriber identity module (USIM)/universal IC card (UICC) ID (for example, in a case of a 3G terminal), and a terminal ID (in a case of a 2D terminal), and the like), for supporting use of a service through Internet (web) access may be stored and managed in the database 211, and the control unit 210 may control provision of a marketing service by controlling access of the user terminal 110 and the like based on the stored and managed membership information.

Particularly, the affiliated card information management unit 220 may collect the benefit information (the affiliated card information) about the member stores of the various financial cards from the card company servers 130, and store and manage the collected benefit information in the database 211, and further, an operator inputs the benefit information (the affiliated card information) about the member stores of the various financial cards obtained from card companies through a user interface screen image provided by the affiliated card information management unit 220, thereby making the input benefit information be stored and managed in the database 211. Here, the input benefit information (the affiliated card information) about the member stores of the various financial cards managed in the database 211 may include a card identifier (card ID/name, and the like), a member store ID (an ID used in a member store DB managed by a corresponding card company, and the like), a member store name (store name), a location of a member store (address information including Haengjeong-dong, Beobjeong-dong, or the like, global positioning system (GPS) location information ((latitude, longitude, altitude, and the like), base station location information, and the like), benefit information (the discounted amount of money, a discount rate, and the like), and the like for each affiliated card company identifier (card company ID/name, and the like) as illustrated in FIG. 3.

The expenditure simulation unit 240 may compare the information about the actual expenditure details input by the user (see FIG. 4) (information on a name and a position of the member store for each expenditure paid by a financial card, cash, or banking) and the affiliated card information (see FIG. 3), and provide a card expected benefit result for a corresponding financial card when the user uses one or more financial cards in the affiliated card information at one or more member stores, and for example, the expenditure simulation unit 240 may compare the information on the name and the position of the member store for each card included in the affiliated card information with the information on the name and the position of the member store for each expenditure included in the expenditure detail information, and provide a card expected benefit result for a financial card to be used at one or more member stores matched with the information on the name and the position of the corresponding member store.

In this case, the expenditure simulation unit 240 may receive the information about the expenditure details at the plurality of member stores through the expenditure detail input unit 230 as illustrated in FIG. 4, and provide a corresponding card expected benefit result when the user uses only a corresponding financial card at a plurality of corresponding member stores for each of all of the corresponding financial cards, and in this case, the card expected benefit result may include a benefit result when the user uses the corresponding expenditure financial card at the plurality of member stores according to the expenditure details for use of the financial card in the aforementioned information about the expenditure details

The expenditure simulation unit 240 may separately display and provide a name of an optimum financial card having the highest discounted amount of money and benefit information about the corresponding financial card (the discount amount of money or a discount rate at one or more member stores) included in the card expected benefit result among all of the corresponding financial cards as recommendation information on a display means of the user terminal 110, and thus, the SNS connection unit 250 may transmit the name of the corresponding optimum financial card and the benefit information about the corresponding financial card to a server on the network providing a promotion service, such as an SNS service, and promote the corresponding financial card.

The additional service unit 260 may determine whether the corresponding optimum financial card is a currently possessed card of the corresponding user according to user's selection in a predetermined evaluation window (for example, “LIKE”) provided by the display means for the name of the corresponding optimum financial card and the benefit information about the corresponding financial card provided on the display means of the user terminal 110, and perform a procedure for inducing the user to apply new subscription of the corresponding optimum financial card when the user does not possess the corresponding optimum financial card.

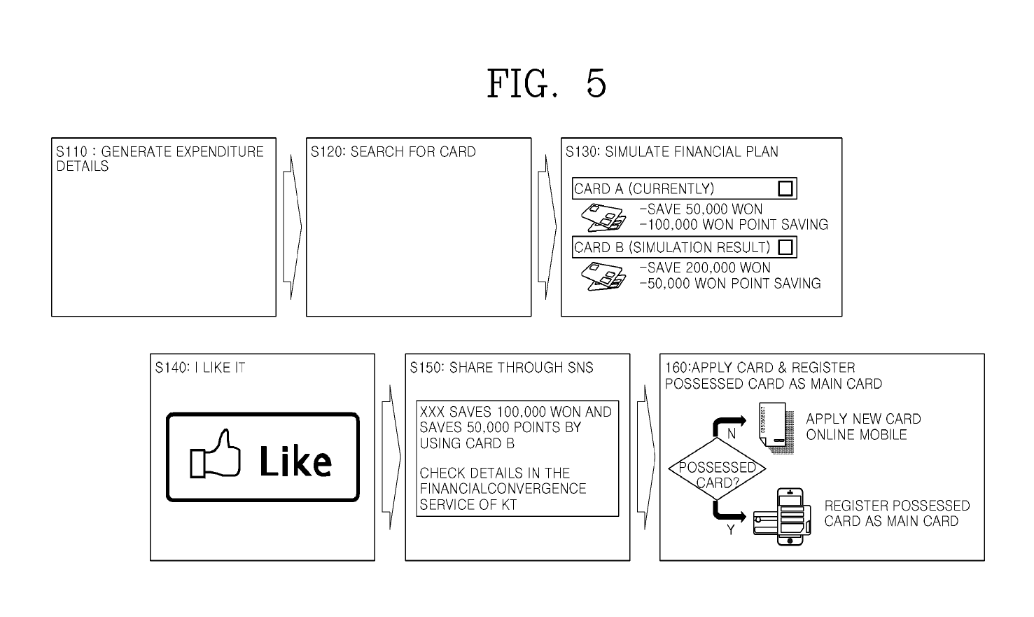

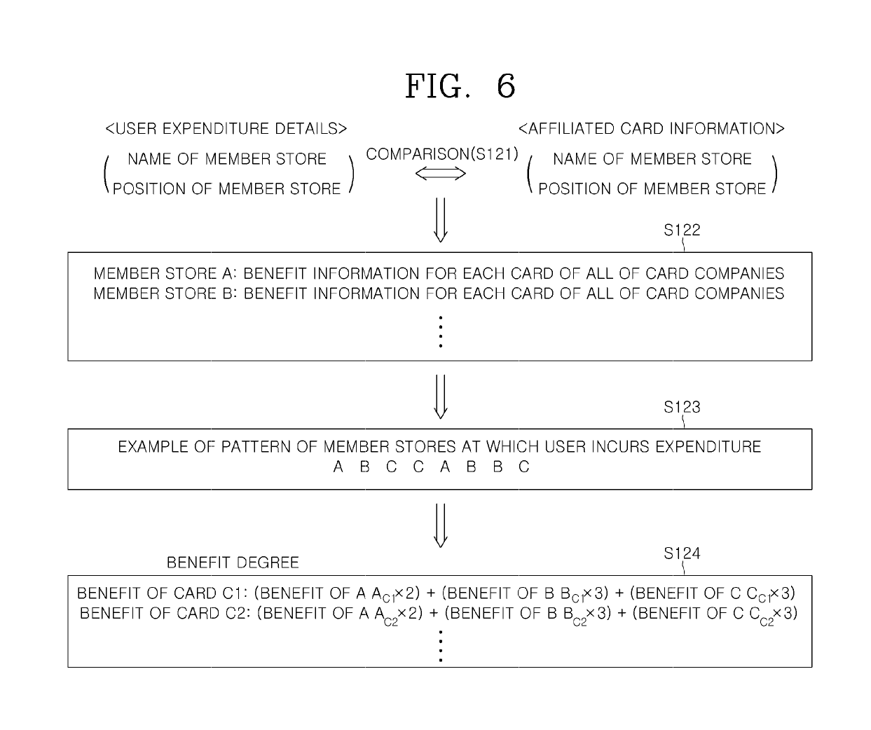

Hereinafter, the operation of the card marketing system 100 according to the exemplary embodiment of the present invention will be described in more detail with reference to flowcharts of FIGS. 5 and 6.

As already described above, the benefit information (the affiliated card information) about the member stores of the various financial cards, which the affiliated card information management unit 220 collects from the card company servers 130 and the like and manages, may be divided into a card identifier (card ID/name, and the like), a member store ID (an ID used in a member store DB managed by a corresponding card company, and the like), a member store name (store name), a location of a member store (address information including Haengjeong-dong, Beobjeong-dong, or the like, global positioning system (GPS) location information ((latitude, longitude, altitude, and the like), base station location information, and the like), benefit information (the discounted amount of money, a discount rate, and the like), and the like for each affiliated card company identifier (card company ID/name, and the like) as illustrated in FIG. 3 to be established in the database 211.

As described above, in order to perform a simulation for providing the card benefit information (the name of the optimum financial card and the benefit information about the corresponding financial card, and the like) including an optimum card benefit based on the benefit information (affiliated card information) for the member stores of the various financial cards of several card companies established in the database 211, first, the user may access the card marketing server 120 through the user terminal 110, select a predetermined menu item for the simulation displayed on a screen, and input the information about the expenditure details illustrated in FIG. 4, and the expenditure detail input unit 230 may receive the corresponding information input by the user, match the received information with corresponding membership information, and store and manage the matched information in the database 211 in step S110.

The user may input information about actual expenditure details processed by payment with a financial card, payment with cash, or payment with banking (telebanking, Internet banking, a deposit without a bankbook, and the like) at one or more member stores while paying utility bills, a computer purchase expense, an expense for meal, a membership fee, other home appliance purchase expense, and the like, and the information about the expenditure details may include a name of the member store (store name), a position of the member store (address information including Haengjeong-dong, Beobjeong-dong, or the like, global positioning system (GPS) location information ((latitude, longitude, altitude, and the like), base station location information, and the like), a date of expenditure, the using amount of money (expenditure money), and the like.

The information about the expenditure details may be stored and managed in a form of a cash book in the user terminal 110, and in this case, the user may input a corresponding cash book file through an information input screen image provided by the expenditure detail input unit 230, so that the expenditure detail input unit 230 may automatically extract the information about the expenditure details from the corresponding file and store and manage the extracted information about the expenditure details in the database 211. The aforementioned cash book may include, for example, information automatically or manually stored in the user terminal 110, when the user incurs a payment with a financial card at a member store and is notified of authentication details (a card name, the name and the position of the member store, the using amount of money, and the like) from a financial organization or information about expenditure details (a name and a position of a member store, date, and the using amount of money) with cash or banking, in addition to a financial card, personally stored in a function of the cash book of the user terminal 110.

After the user inputs the information about the expenditure details as described above, the user makes a request for a simulation by selecting a predetermined menu item, for example, by searching for a card in the affiliated cards, displayed on the screen through the user terminal 110 in step S120. According to the request of the simulation, the expenditure simulation unit 240 may compare the information about actual expenditure details of the user (see FIG. 4, information on names and locations of the member stores of the respective expenditure money settled with the financial card, cash, or banking, and the like) at one or more member stores and the affiliated card information (see FIG. 3) for a specific time input by the user, and provide a card expected benefit result of a corresponding financial card when the user uses one or more financial cards in the affiliated card information at one or more member stores in step S130.

For example, the expenditure simulation unit 240 may compare the information on the name and the position of the member store for each card included in the affiliated card information (see FIG. 3) and the information on the name and the position of the member store for each expenditure money included in the information about the expenditure details (see FIG. 4), and provide a card expected benefit result for a financial card to be used at one or more member stores of which information on names and locations are matched with the information on the name and the position of the corresponding member store, for example, information about the discount amount of money, such as the saved amount of money and points saved, or a discount rate, such as 5% discount or 10% discount.

More particularly, when the expenditure simulation unit 240 receives the information about the expenditure details at the plurality of member stores through the expenditure detail input unit 230 as illustrated in FIG. 4, the expenditure simulation unit 240 may provide a corresponding card expected benefit result when the user uses only a corresponding financial card at the plurality of corresponding member stores for each of all of the corresponding financial cards, and in this case, the card expected benefit result may include the benefit result when the user uses the corresponding expenditure financial card at the plurality of corresponding member stores, according to the expenditure details for the use of the financial card (except for the settlement with cash or banking) in the information about the expenditure details.

For example, referring to FIG. 6, the expenditure simulation unit 240 may compare the information on the name and the position of the member store for each card included in the affiliated card information (see FIG. 3) and the information on the name and the position of the member store for each expenditure money included in the information about the expenditure details (see FIG. 4) in step S121, and first extract benefit information (the discount amount of money or a discount rate) for each financial card of all of the card companies for the member stores, of which the names and the location information are matched with the information on the name and the position of the corresponding member store, from the database 211 in step S122. Further, the expenditure simulation unit 240 may extract patterns of the member stores of which the names and the location information are matched with the information on the name and the position of the corresponding member store, that is, patterns of the member stores at which the user makes expenditure from the information about the expenditure details (see FIG. 4) as described above, and count the number of times of use at each member store in step S123.

Accordingly, the expenditure simulation unit 240 may provide the corresponding card expected benefit result when the user uses only the corresponding financial card at the plurality of corresponding member stores for each of all of the corresponding financial cards of the information on the expenditure details (see FIG. 4) in step S124. For example, when the user uses the financial card two times at member store A, three times at member store B, and three times at member store C like step S123, card expected benefit result F1 (a benefit of each member store (the discount amount of money or the expenditure money×a discount rate×the number of times of use at each member store) when only card C1 is used at member stores A, B, and C in the information about the expenditure details (see FIG. 4) may be calculated like step S124, and by the same method, card expected benefit results F2, F3, and . . . when the user uses only cards, C2, C3, . . . (for example, the user uses cards C1, C2, C3, . . . at member stores A, B, and C) at member stores A, B, and C in the information about the expenditure details (see FIG. 4) may be calculated, respectively.

In the above example, the expenditure simulation unit 240 may provide the card expected benefit result, for example, information about the discount amount of money, such as the saved amount of money and points saved, or a discount rate, such as 5% discount or 10% discount, and the like, for the financial card to be used at one or more member stores of which the names and the location information are matched with the name and the location information about the corresponding member store, for only the expenditure details for the use of the expenditure financial card in the information about the expenditure details (see FIG. 4), but is not limited thereto, and the expenditure simulation unit 240 may provide a corresponding card expected benefit result when the user uses only the corresponding financial card at the plurality of corresponding member stores for each of all of the financial cards of the database 211 based on the benefit information for each card in step S122 and the number of times of use of the card at each member store according to the pattern of step S123 by the aforementioned method. When information about payment with cash or banking, in addition to the financial card, is included in the information about the expenditure details (see FIG. 4), the aforementioned method may be similarly applied thereto.

In the meantime, in FIG. 5, when the expenditure simulation unit 240 provides the expected benefit result for each financial card, the expenditure simulation unit 240 may display a name of an optimum financial card having the highest discount amount of money and benefit information (the discount amount of money or a discount rate of at least one member store) about the corresponding card included in the card expected benefit result among all of the corresponding financial cards with a separate window or on the topmost portion of the display means of the user terminal 110 as recommendation information, and may provide the expected benefit result by sequentially arranging the remaining financial cards so that the financial card having a larger benefit is displayed at a higher side.

According to the performance of the simulation by the expenditure simulation unit 240, a fee may be charged on the card company, that is, the card company issuing the corresponding financial card when providing the user terminal 110 with the benefit result. To this end, the expenditure simulation unit 240 may count the number of times of provision of the information about the corresponding financial card when the benefit result is provided for a predetermined time (for example, one week or one month), calculate a corresponding fee, and send a charge bill to the corresponding card company server 130 in a predetermined period, or send a bill for charging to the corresponding card company in a form of a paper bill, an e-mail bill, and a text message. Otherwise, the simulation performed by the expenditure simulation unit 240 ranges to the expenditure details within a predetermined time (for example, one week or one month) from a simulation date based on an expenditure date in the information about the expenditure details (see FIG. 4) according to a contract condition when the benefit information (affiliated card information) about the member store of the financial card of the corresponding card company is collected. A fee rate may be changed during the charging according to the simulation range, and the expenditure simulation unit 240 may calculate and claim the charge in which the aforementioned simulation range is reflected.

On the other hand, when the expenditure simulation unit 240 provides the user terminal 110 with the name of the optimum financial card and the benefit information about the corresponding financial card (the discount amount of money, the discount rate at one or more member stores, or the like) as described above as the recommendation information, and then, the user selects the predetermined evaluation window (for example, “LIKE”) provided by the display means for the name of the corresponding optimum financial card and the benefit information about the corresponding financial card provided on the display means of the user terminal 110 in step S140, the SNS connection unit 250 may transmit the name of the corresponding optimum financial card and the benefit information about the corresponding financial card to a server on the network providing the SNS services (Twitter, Facebook, Kakao talk, and the like), and promote (advertise) the corresponding financial card through various media through the N-Screen (S150). In this case, the corresponding simulation result (the name of the corresponding optimum financial card and the benefit information about the corresponding financial card) may be promoted through the SNS service after acquiring agreement of the user through the user terminal 110 in accordance with a personal information protection policy. When the corresponding financial card is exposed to the advertisement, the SNS connection unit 250 may charge the fee to the corresponding card company, that is, the card company issuing the corresponding financial card when providing the user terminal 110 with the benefit result, that is, the name of the corresponding optimum financial card and the benefit information about the corresponding financial card. The number of times of exposure of the corresponding financial card may be set, the payment may be received in advance, and then the advertisement may be performed through the SNS service, and the SNS connection unit 250 may count the number of times of exposure of the corresponding financial card to the advertisement for a predetermined time (for example, one week or one month), calculate corresponding fee, and send a charge bill to the corresponding card company server 130 in a predetermined period, or send a bill for charging to the corresponding card company in a form of a paper bill, an e-mail bill, a text message, and the like.

In addition, according to the user's selection of the predetermined evaluation window (for example, “LIKE”), the additional service unit 260 may determine whether the corresponding optimum financial card is a currently possessed card of the corresponding user, and perform a procedure for inducing the user to apply new subscription of the corresponding optimum financial card when the user does not possess the corresponding optimum financial card in step S160. For example, the additional service unit 260 may provide the user terminal 110 with question contents for confirming whether the user possesses the corresponding card, and in this case, when the user inputs information indicating that the user does not currently possess the corresponding card, the additional service unit 260 may provide the user terminal 110 with a new subscription application sheet having a predetermined form for new subscription application. Accordingly, the user may write contents, such as a name and a resident registration number, necessary for card issuance in the new subscription application sheet and transmit the new subscription application sheet through the user terminal 110, and the additional service unit 260 may receive the new subscription application sheet and transmit the received new subscription application sheet to the card company server 130 and the like, and thus may claim a charge according to a predetermined fee rate to the corresponding card company.

Further, according to the user's selection of the predetermined evaluation window (for example, “LIKE”), the additional service unit 260 may determine whether the corresponding optimum financial card is a mobile card possessed by the corresponding user, and perform a procedure for inducing the user to register the corresponding optimum financial card as a main card (a basically used card among several mobile cards stored in an electronic wallet, such as USIM) among mobiles cards which are capable of interlocking with the electronic wallet of the user terminal 110. For example, the additional service unit 260 may provide the user terminal 110 with question contents for confirming whether the user possesses the corresponding card, and in this case, when the user inputs information indicating that the user possesses the corresponding card, the additional service unit 260 may further provide question contents for guiding the user to register the corresponding card among the mobile cards as the main card, acquire a user's confirmation, and then register the corresponding card as the main card of the electronic wallet. Even in this case, the additional service unit 260 may claim a charge according to a predetermined fee rate to the corresponding card company for the registration of the corresponding card as the main card.

The functions used in the aforementioned system and method of card marketing according to the exemplary embodiment of the present invention may be implemented by computer readable codes in a computer readable recording medium. The computer readable recording medium includes every type of recording device in which data readable by a computer system is stored. Examples of the computer readable recording medium are ROM, RAM, CD-ROM, a magnetic tape, a floppy disk, an optical data storing device, a hard disk, and a mobile storage device, and also a medium implemented in a form of a carrier wave (for example, transmission through the Internet). Further, it is noted that the computer-readable recording media are distributed on computer systems connected through the network, and thus stored and executed in the form of the computer-readable code by a distribution scheme.

As described above, although the present invention has been described by limited embodiments and drawings, the present invention is not limited to the embodiments, and it will be apparent to those skilled in the art to which the present invention pertains that various modifications and variations may be made from the description. Therefore, the scope of the present invention should not be defined by being limited to the examples described, but should be defined by the claims to be described below and those equivalent to the claims.

1. A method of card marketing for inducing and promoting use of an optimum card, comprising steps of:
(A) collecting benefit information (affiliated card information) about member stores of various financial cards and maintaining the collected benefit information (affiliated card information) in a database;
(B) receiving information on expenditure details of a user at one or more member stores; and
(C) comparing the information about the expenditure details and the affiliated card information, and providing a card expected benefit result for a corresponding financial card when the user uses one or more financial cards in the affiliated card information at the one or more member stores.

2. The method of claim 1, wherein the information about the expenditure details is information about actual expenditure details of the user for a specific period.

3. The method of claim 1, wherein step (C) includes comparing information on a name and a position of a member store for each card included in the affiliated card information, and information on a name and a position of a member store for each expenditure money included in the information about the expenditure details, and providing a card expected benefit result of a financial card to be used at the one or more member stores of which information on names and locations are matched with the information on the name and the position of the corresponding member store.

4. The method of claim 1, wherein the information about the expenditure details includes information on a name and a position of a member store for each expenditure money paid by a financial card, cash, or banking.

5. The method of claim 1, wherein step (B) includes receiving information about expenditure details from a plurality of member stores, and step (C) includes providing a corresponding card expected benefit result when only a corresponding financial card is used at the plurality of member stores for each of all of the corresponding financial cards.

6. The method of claim 5, wherein the card expected benefit result includes a benefit result when a corresponding expenditure financial card is used at the plurality of member stores according to expenditure details for use of the financial card in the information about the expenditure details.

7. The method of claim 5, further comprising steps of:
separately displaying, on a display means, and providing a name of an optimum financial card having the highest discount amount of money and benefit information about the corresponding financial card included in the card expected benefit result in all of the corresponding financial cards as recommendation information.

8. The method of claim 7, wherein the benefit information about the optimum financial card includes the discount amount of money or a discount rate at one or more member stores.

9. The method of claim 7, further comprising steps of:
transmitting the name of the optimum financial card and the benefit information about the corresponding financial card to a server on a network, which provides a promotion service, and promoting the corresponding financial card.

10. The method of claim 7, further comprising steps of:
determining whether the optimum financial card is a possessed card of the user, and performing a procedure of inducing the user to apply new subscription of the optimum financial card when the user does not possess the optimum financial card.

11. A system for card marketing for inducing and promoting use of an optimum card, comprising:
an affiliated card information management unit configured to collect benefit information (affiliated card information) about member stores of various financial cards and manage the collected benefit information (affiliated card information) in a database;
an expenditure detail input unit configured to receive information about expenditure details at one or more member stores input by a user; and
an expenditure simulation unit configured to compare the information about the expenditure details and the affiliated card information, and provide a card expected benefit result for a corresponding financial card when the user uses one or more financial cards in the affiliated card information at the one or more member stores.
